(19) United States
(12) Patent Application Publication
(10) Pub. No.: US 2024/0185336 A1
(43) Pub. Date: Jun. 6, 2024

(54) ESTABLISHING A DECENTRALIZED FINANCE NETWORK

(71) Applicant: Bank of America Corporation, Charlotte, NC (US)

(72) Inventors: Naga Vamsi Krishna Akkapeddi, Charlotte, NC (US); Siten Sanghvi, Westfield, NJ (US)

(21) Appl. No.: 18/076,041

(22) Filed: Dec. 6, 2022

(51) Int. Cl. G06Q 40/03; G06Q 20/22; G06Q 40/06

(52) U.S. Cl. CPC G06Q 40/03; G06Q 20/223; G06Q 40/06

(57) ABSTRACT

Aspects of the disclosure relate to establishing a decentralized finance network. A computing platform may analyze a consumer request to initiate a transaction. The computing platform may determine a risk score associated with the consumer request and may recommend, based on the risk score, whether to approve or reject the consumer request. The computing platform may receive, from an external lending entity, a notification indicating interest in handling the consumer request and a lending framework, and may receive, from at least one other external lending entity, as assessment of an asset indicated in the consumer request. The computing platform may normalize the assessment data and may generate a token distribution framework. The computing platform may transmit changes in either consumer data or assessment data to the external lending entity, and may update the token distribution framework based on receiving a modified lending framework.

### BACKGROUND

Aspects of the disclosure relate to hardware and/or software for establishing a decentralized finance network. In particular, one or more aspects of the disclosure may relate to establishing a peer-to-peer (P2P) lending network comprising a plurality of external lending entities, identifying an external lending entity to handle a consumer request, and distributing tokens to the external lending entity, wherein the tokens indicate an interest (e.g., property interest, ownership interest, or the like) in at least one asset indicated in the consumer request.

Current financial transaction environments may correspond to at least one finance network. The finance network may identify a spectrum of consumers who may enter into financial transactions with the enterprise organization and/or identify a spectrum of financial transactions that may be supported by the finance network. In some instances, the finance network may correspond to a centralized finance network. Within the centralized finance network, a plurality of consumers (e.g., consumers with a demonstrated financial stability, consumers with an established credit history, consumers affiliated with the enterprise organization, or the like) may initiate a plurality of transactions with an enterprise organization (e.g., commercial mortgage lending transactions, residential mortgage lending transactions, or the like). The enterprise organization may interact with the consumers associated with each transaction, and may analyze and/or process each transaction of the plurality of transactions.

In doing so, the centralized finance network may facilitate communication between the enterprise organization and the consumers, but might not facilitate communication and/or collaboration between the consumers (e.g., peer-to-peer (P2P) communication, or the like). The centralized finance network may restrict the consumers from engaging in P2P lending (e.g., for transactions rejected by the enterprise organization, transactions that might need further funding prior to submission to the enterprise organization, or the like). Within the centralized finance network, consumers who may be interested in initiating financial transactions that might not be supported by the centralized finance network and/or consumers who might not satisfy consumer eligibility criteria might not be permitted to interact with the enterprise organization. Therefore, current financial transaction environments might not offer a finance network that supports an inclusive spectrum of financial transactions, and/or facilitates P2P communication and/or collaboration between consumers.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, and convenient technical solutions that address and overcome the technical problems associated with establishing, in real-time or near real-time, a decentralized finance network.

In accordance with one or more embodiments, a method may comprise, at a computing device, within a peer-to-peer (P2P) lending network, including one or more processors and memory, receiving, from an enterprise organization computing device, a consumer request to initiate a transaction with an enterprise organization. The method may comprise determining, based on analyzing the consumer request, a risk score that corresponds to the consumer request. The method may comprise determining, based on the risk score, whether to approve the consumer request. The method may comprise receiving, from an external lending entity, a notification indicating approval of the consumer request, wherein the notification identifies a total investment amount. The method may comprise receiving, from the enterprise organization computing device, an assessment of an asset, generated by at least one other external lending entity, associated with the consumer request. The method may comprise generating, based on the assessments, a plurality of tokens. The method may comprise distributing tokens, of the plurality of tokens, to the external lending entity and the at least one other external lending entity. The method may comprise receiving, from the enterprise organization computing device, an indication of at least one change to the assessment, wherein the indication is generated by the at least one other external lending entity. The method may comprise transmitting the at least one change to the external lending entity. The method may comprise receiving, from the external lending entity, a notification indicating at least one of no modification to the total investment amount, or at least one modification to the total investment amount.

In accordance with one or more embodiments, a computing platform, within a peer-to-peer (P2P) lending network, may comprise at least one processor, a communication interface communicatively coupled to the at least one processor, and memory storing computer-readable instructions that, when executed by the at least one processor, cause the computing platform to receive, from an enterprise organization computing device, a consumer request to initiate a transaction with an enterprise organization. The computing platform may determine, based on analyzing the consumer request, a risk score that corresponds to the consumer request. The computing platform may determine, based on the risk score, whether to approve the consumer request. The computing platform may receive, from an external lending entity, a notification indicating approval of the consumer request, wherein the notification identifies a total investment amount. The computing platform may receive, from the enterprise organization computing device, an assessment of an asset, generated by at least one other external lending entity, associated with the consumer request. The computing platform may generate, based on the assessments, a plurality of tokens. The computing platform may distribute tokens, of the plurality of tokens, to the external lending entity and the at least one other external lending entity. The computing platform may receive, from the enterprise organization computing device, an indication of at least one change to the assessment, wherein the indication is generated by the at least one other external lending entity. The computing platform may transmit the at least one change to the external lending entity. The computing platform may receive, from the external lending entity, a notification indicating at least one of no modification to the total investment amount, or at least one modification to the total investment amount.

In accordance with one or more embodiments, one or more non-transitory computer-readable media storing instructions that, when executed by a computing platform, within a peer-to-peer (P2P) lending network, comprising at least one processor, memory, and a communication interface, cause the computing platform to receive, from an enterprise organization computing device, a consumer request to initiate a transaction with an enterprise organization. The instructions, when executed, may cause the computing platform to determine, based on analyzing the consumer request, a risk score that corresponds to the consumer request. The instructions, when executed, may cause the computing platform to determine, based on the risk score, whether to approve the consumer request. The instructions, when executed, may cause the computing platform to receive, from an external lending entity, a notification indicating approval of the consumer request, wherein the notification identifies a total investment amount. The instructions, when executed, may cause the computing platform to receive, from the enterprise organization computing device, an assessment of an asset, generated by at least one other external lending entity, associated with the consumer request. The instructions, when executed, may cause the computing platform to generate, based on the assessments, a plurality of tokens. The instructions, when executed, may cause the computing platform to distribute tokens, of the plurality of tokens, to the external lending entity and the at least one other external lending entity. The instructions, when executed, may cause the computing platform to receive, from the enterprise organization computing device, an indication of at least one change to the assessment, wherein the indication is generated by the at least one other external lending entity. The instructions, when executed, may cause the computing platform to transmit the at least one change to the external lending entity. The instructions, when executed, may cause the computing platform to receive, from the external lending entity, a notification indicating at least one of no modification to the total investment amount, or at least one modification to the total investment amount.

These features, along with many others, are discussed in greater detail below.

### BRIEF DESCRIPTION OF THE DRAWINGS

The present disclosure is illustrated by way of example and is not limited in the accompanying figures in which like reference numerals indicate similar elements and in which:

FIG. 1A depicts an illustrative example of a computer system for establishing a decentralized finance network, in accordance with one or more example embodiments.

FIG. 1B depicts an illustrative example of the computing platform that may be used for establishing a decentralized finance network, in accordance with one or more example embodiments.

FIGS. 2A-2C depict an illustrative event sequence for establishing a decentralized finance network, in accordance with one or more example embodiments.

FIG. 3 depicts an illustrative method for establishing a decentralized finance network, in accordance with one or more example embodiments.

### DETAILED DESCRIPTION

In the following description of various illustrative embodiments, reference is made to the accompanying drawings, which form a part hereof, and in which are shown, by way of illustration, various embodiments in which aspects of the disclosure may be practiced. It is to be understood that other embodiments may be utilized, and structural and functional modifications may be made, without departing from the scope of the present disclosure. Various aspects are capable of other embodiments and of being practiced or being carried out in various different ways.

It is noted that various connections between elements are discussed in the following description. It is noted that these connections are general and, unless specified otherwise, may be direct or indirect, wired or wireless, and that the specification is not intended to be limiting in this respect.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

As discussed above, current financial transaction environments might not offer a finance network that supports an inclusive spectrum of financial transactions, and/or facilitates P2P communication and/or collaboration between consumers and entities outside of the enterprise organization. Accordingly, proposed herein is a solution to the problem described above that includes establishing a decentralized finance network. For example, an enterprise organization computing device may receive, from a consumer computing device, a request to initiate and/or execute a transaction with the enterprise organization. A computing platform may determine a risk score associated with the consumer request and may analyze the risk score to determine whether to approve or reject the consumer request. The computing platform may transmit, to the enterprise organization computing device, the analysis of the risk score and the recommendation indicating one of approval or rejection of the consumer request. The enterprise organization computing device may determine whether to approve or reject the consumer request based on the received analysis of the risk score. Based on rejecting the consumer request, the enterprise organization computing device may identify an external lending entity computing device that may be interested in handling (e.g., financing) the consumer request and may transmit the consumer request to the external lending entity computing device. The external lending entity computing device may analyze the consumer request to determine whether to approve and/or handle the consumer request. In some instances, the external lending entity computing device may reject the consumer request and may transmit a notification indicating the same to the enterprise organization computing device and the computing platform. Alternatively, the external lending entity computing device may approve the consumer request, generate a lending framework associated with the consumer request, and/or transmit a notification indicating the same to the enterprise organization computing device, the consumer computing device, and the computing platform.

The computing platform may request, from at least one external lending entity computing device, an assessment of the consumer request and may receive assessment data from the at least one external lending entity computing device. The computing platform may aggregate and normalize the assessment data to generate training data. The computing platform may generate and distribute tokens to the external lending entity computing device handling the request and/or to the at least one different lending entity computing device that assessed the consumer request. The computing platform may continuously monitor consumer data and assessment data, and may transmit detected changes to the external lending entity computing device handling the consumer request. The external lending entity computing device may determine whether to modify the lending framework based on the detected changes. In some instances, the external lending entity computing device might not modify the lending framework and may transmit a notification indicating the same to the computing platform. Alternatively, the external lending entity computing device may modify the lending framework and may transmit a notification indicating the same to the computing platform. The computing platform may modify the token distribution in accordance with the modified lending framework.

### Computer Architecture

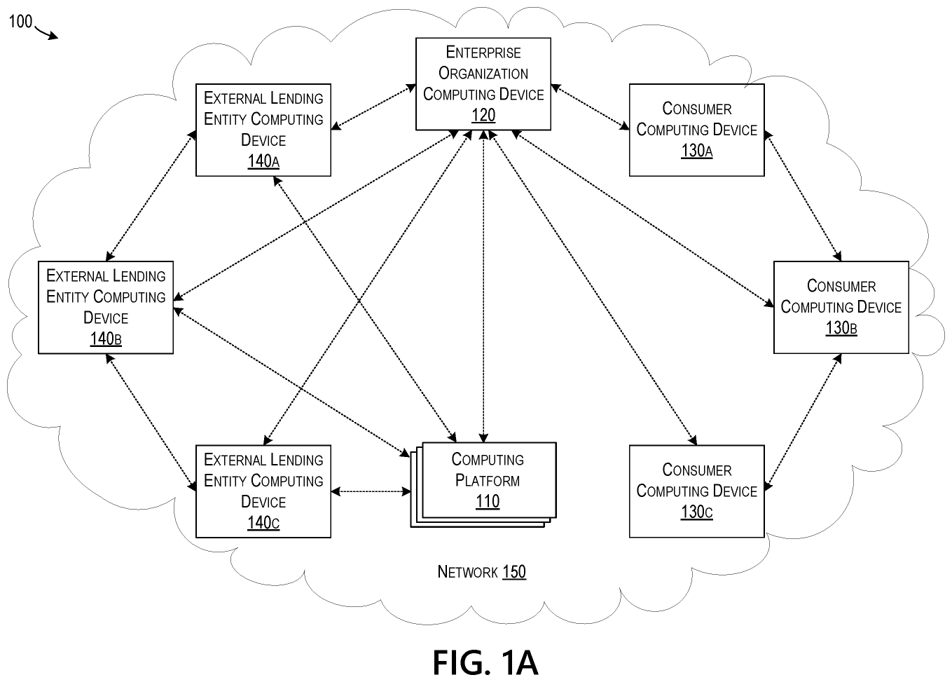

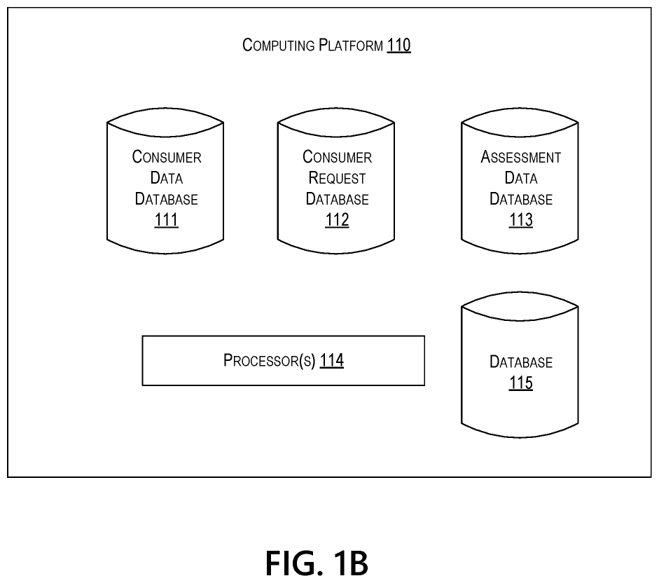

FIG. 1A depicts an illustrative example of a computer system 100 that may be used for establishing, in real-time or near real-time, a decentralized finance network, in accordance with one or more aspects described herein. Computer system 100 may correspond to a decentralized peer-to-peer (P2P) lending network that may be used to identify at least one external lending entity that may handle a consumer request. Computer system 100 may comprise one or more computing devices including at least computing platform 110, enterprise organization computing device 120, consumer computing devices 130a-130c, and/or external lending entity computing devices 140a-140c.

While FIG. 1A depicts more than one consumer computing device (e.g., consumer computing devices 130a-130c) and more than one external lending entity computing device (e.g., external lending entity computing devices 140a-140c), each of consumer computing device 130 and external lending entity computing device 140 may be configured in accordance with the features described herein. While the description herein may refer to consumer computing device 130 and external lending entity computing device 140, the functions described in connection with consumer computing device 130 and external lending entity computing device 140 may also be performed by any one of consumer computing devices 130a-130c and external lending entity computing devices 140a-140c. While FIG. 1A depicts enterprise organization computing device 120, consumer computing devices 130a-130c, and external lending entity computing device 140a-140c, more or fewer enterprise organization computing devices, consumer computing devices, and/or external lending entity computing devices may exist within computer system 100. Enterprise organization computing device 120, consumer computing devices 130a-130c, and external lending entity computing devices 140a-140c are depicted in FIG. 1A for illustration purposes only and are not meant to be limiting.

Computer system 100 (e.g., using the decentralized P2P lending system) may facilitate communication between the computing devices therein. Each of consumer computing devices 130a-130c may communicate with a different one of consumer computing devices 130a-130c through network 150. Similarly, each of external lending entity computing devices 140a-140c may communicate with a different one of external lending entity computing devices 140a-140c through network 150. Network 150 may include one or more sub-networks (e.g., local area networks (LANs), wide area networks (WANs), or the like).

Consumer computing devices 130a-130c (or external lending entity computing devices 140a-140c) may communicate independently of enterprise organization computing device 120. In particular, communication between consumer computing devices 130a-130c (or external lending entity computing devices 140a-140c) might not be routed through enterprise organization computing device 120 (e.g., before being transmitted to a different one of consumer computing devices 130a-130c (or external lending entity computing devices 140a-140c), or the like).

Additionally or alternatively, consumer computing device 130 and/or external lending entity computing device 140 may communicate with enterprise organization computing device 120 through network 150. Enterprise organization computing device 120 may be configured to communicate with computing platform 110, and the computing devices therein, via network 150. In some arrangements, computer system 100 may include additional computing devices and networks that are not depicted in FIG. 1A, which may also be configured to interact with at least one computing platform 110, enterprise organization computing device 120, consumer computing device 130, and/or external lending entity computing device 140.

Computing platform 110 may be associated with a distinct entity such as an enterprise organization, company, school, government, and the like, and may comprise one or more personal computer(s), server computer(s), hand-held or laptop device(s), multiprocessor system(s), microprocessor-based system(s), set top box(es), programmable user electronic device(s), network personal computer(s) (PC), minicomputer(s), mainframe computer(s), distributed computing environment(s), and the like. Computing platform 110 may include computing hardware and software that may host various data and applications for performing tasks of the centralized entity and interacting with enterprise organization computing device 120, external lending entity computing devices 140a-140c, and/or additional computing devices.

In some arrangements, computing platform 110 may include and/or be part of enterprise information technology infrastructure and may host a plurality of enterprise applications, enterprise databases, and/or other enterprise resources. Such applications may be executed on one or more computing devices included in computing platform 110 using distributed computing technology and/or the like. In some instances, computing platform 110 may include a relatively large number of servers that may support operations of the enterprise organization, such as a financial institution. Computing platform 110, in this embodiment, may generate a single centralized ledger, which may be stored in a database (e.g., database 115), for data received from at least one of enterprise organization computing device 120, consumer computing devices 130a-130c, and/or external lending entity computing devices 140a-140c.

Enterprise organization computing device 120 may be configured to receive and transmit information corresponding to requests through particular channels and/or applications associated with computing platform 110. The requests submitted by enterprise organization computing device 120 may initiate the performance of particular computational functions at computing platform 110, such as identifying at least one external lending entity to handle (e.g., finance) a consumer request to initiate a transaction with the enterprise organization.

Enterprise organization computing device 120 may receive a consumer request to initiate a transaction with the enterprise organization and may instruct the computing platform to analyze the request. Enterprise organization computing device 120 may receive, from the computing platform, an analysis of the consumer request and a recommendation, based on a risk score associated with the consumer request, of whether the consumer request should be approved or rejected. Enterprise organization computing device 120 may approve or reject the consumer request based on the analysis received from the computing platform. In instances where enterprise organization computing device 120 rejects the consumer request, enterprise organization computing device 120 may identify at least one external lending entity to handle the consumer request. Enterprise organization computing device 120 may receive, from a plurality of external lending entities, assessment data that corresponds to the consumer request and may instruct the computing platform to analyze the assessment data.

Consumer computing device 130 may generate a request to initiate a transaction with the enterprise organization and may transmit the request to the enterprise organization computing device. In some instances, consumer computing device 130 may receive, from the enterprise organization computing device, a notification indicating approval of the consumer request. Alternatively, consumer computing device 130 may receive, from the external lending entity computing device, a notification indicating one of approval or rejection of the consumer request.

External lending entity computing device 140 may receive, from the enterprise organization computing device, a request to establish a lending framework to handle the consumer request. In some instances, external lending entity computing device 140 may reject the consumer request. However, based on approving the consumer request, external lending entity computing device 140 may transmit the lending framework to the enterprise organization computing device, the consumer computing device, and the computing platform. External lending entity computing device 140 may receive tokens from the computing platform. External lending entity computing device 140 may determine whether to modify the lending framework based on continuously receiving, from the computing platform, changes to consumer data and/or assessment data.

FIG. 1B depicts example components of computing platform 110 that may be used for establishing, in real-time or near real-time, a decentralized finance network, in accordance with one or more aspects described herein. Computing platform 110 may comprise consumer data database 111, consumer request database 112, assessment data database 113, processor(s) 114, and/or database 115. Each computing device within computing platform 110 may contain processor(s) 114 and database 115, which may be stored in the memory of the one or more computing devices of computing platform 110. Through execution of computer-readable instructions stored in memory, the computing devices of computing platform 110 may be configured to perform functions of the centralized entity and store the data generated during the performance of such functions in database 115.

Computing platform 110 may receive, from the enterprise organization computing device, instructions to analyze the consumer request. Computing platform 110 may determine a risk score that corresponds to the consumer request and may compare the risk score to a risk threshold value. Based on the comparison, computing platform 110 may recommend whether to accept or reject the consumer request, and may transmit the analysis of the risk score and the recommendation to the enterprise organization computing device. Computing platform 110 may receive, from the external lending entity computing device, a notification indicating approval of the consumer request and a lending framework. Computing platform 110 may request, from at least one other external lending entity, an assessment of an asset indicated in the consumer request. Computing platform 110 may normalize the assessment data and may distribute tokens based on a token distribution framework. Computing platform 110 may receive, from the external lending entity computing device, a modified lending framework and may modify the token distribution framework accordingly.

Consumer data database 111 may comprise data that corresponds to each consumer computing device (e.g., consumer computing devices 130a-130c) that may generate and transmit a request to initiate a transaction with the enterprise organization (e.g., a credit score associated with a consumer computing device, a credit history associated with the consumer computing device, an account balance associated with the consumer computing device, an employment history associated with the consumer computing device, an outstanding loan repayment balance associated with the consumer computing device, or the like). Consumer data database 111 may further comprise personal identifiable information that describes each consumer computing device (e.g., a unique identifier associated with the consumer computing device, a geographic location associated with the consumer computing device, a method of communication associated with the consumer computing device, or the like). Consumer data database 111 may store dynamic data (e.g., the consumer data may be continuously updated based on detecting at least one modification to the consumer data, or the like).

Access to consumer data database 111 may depend on the computing device requesting access (e.g., a hierarchy of accessibility). Computing platform 110 and enterprise organization computing device 120 may be associated with a first level of accessibility (e.g., a least restrictive level of accessibility). As such, computing platform 110 and enterprise organization computing device 120 may be authorized to perform functions on the data within consumer data database 111 (e.g., access consumer data, add consumer data, remove consumer data, modify consumer data, or the like). External lending entity computing device 140 may be associated with a second level of accessibility (e.g., a more restrictive level of accessibility that the first level of accessibility). External lending entity computing device 140 may be configured to view consumer data, but might not be permitted to add, remove, and/or modify consumer data within consumer data database 111.

Consumer request database 112 may comprise a log of previously received consumer requests. The previously received consumer requests may be stored based on similarities between the consumer requests (e.g., consumer requests that correspond to a particular subset of transactions may be stored together, or the like). Consumer request database 112 may further comprise a risk score associated with each stored consumer request and an indication of whether enterprise organization computing device 120 approved or rejected the consumer request. In instances where the consumer request was rejected, consumer request database 112 may indicate at least one reason why enterprise organization computing device 120 may have rejected the consumer request. Consumer request database 112 may further comprise an indication of whether at least one external lending entity computing device approved or rejected the consumer request.

Access to consumer request database 112 may depend on the computing device requesting access (e.g., a hierarchy of accessibility). Computing platform 110 and enterprise organization computing device 120 may be associated with a first level of accessibility (e.g., a least restrictive level of accessibility). As such, computing platform 110 and enterprise organization computing device 120 may be authorized to perform functions on the data within consumer request database 112 (e.g., access consumer request data, add consumer request data, remove consumer request data, modify consumer request data, or the like). The remaining computing devices may be associated with a second level of accessibility (e.g., a more restrictive level of accessibility that the first level of accessibility). The remaining computing devices may be configured to view consumer request data, but might not be permitted to add, remove, and/or modify consumer request data within consumer request database 112.

Assessment data database 113 may comprise assessment data that describes at least one asset indicated within the consumer request (e.g., a value of an asset, a geographic location of a physical asset, a network location of a digital asset, an indication of features associated with the asset, an indication of damage sustained by the asset, an indication of comparable assets and/or corresponding values, or the like). Assessment data database 113 may store dynamic data (e.g., the assessment data may be continuously updated based on detecting at least one modification to the assessment data, or the like). Assessment data database 113 may further store a log indicating previously generated assessment data.

Access to assessment data database 113 may depend on the computing device requesting access (e.g., a hierarchy of accessibility). External lending entity computing device 140 may be associated with a first level of accessibility (e.g., a least restrictive level of accessibility). As such, an external lending entity computing device 140 may be authorized to perform functions on the assessment data within assessment data database 113 (e.g., access assessment data, add assessment data, remove assessment data, modify assessment data, or the like). The remaining computing devices may be associated with a second level of accessibility (e.g., a more restrictive level of accessibility that the first level of accessibility). The remaining computing devices may be configured to view assessment data, but might not be permitted to add, remove, and/or modify assessment data within assessment data database 113.

### Establishing a Decentralized Finance Network

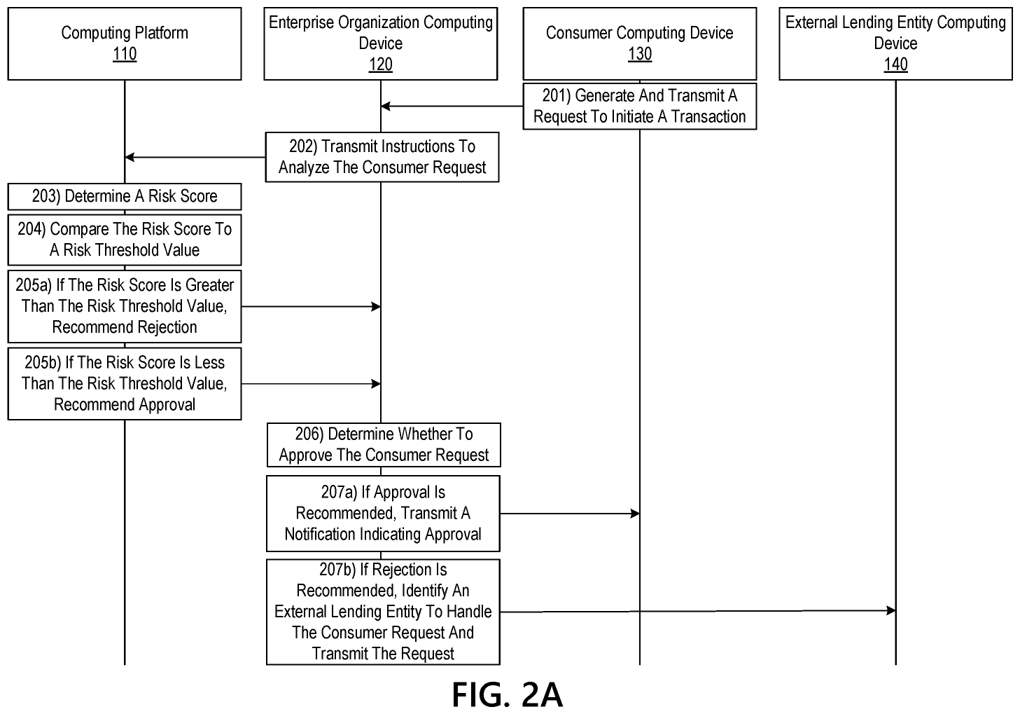

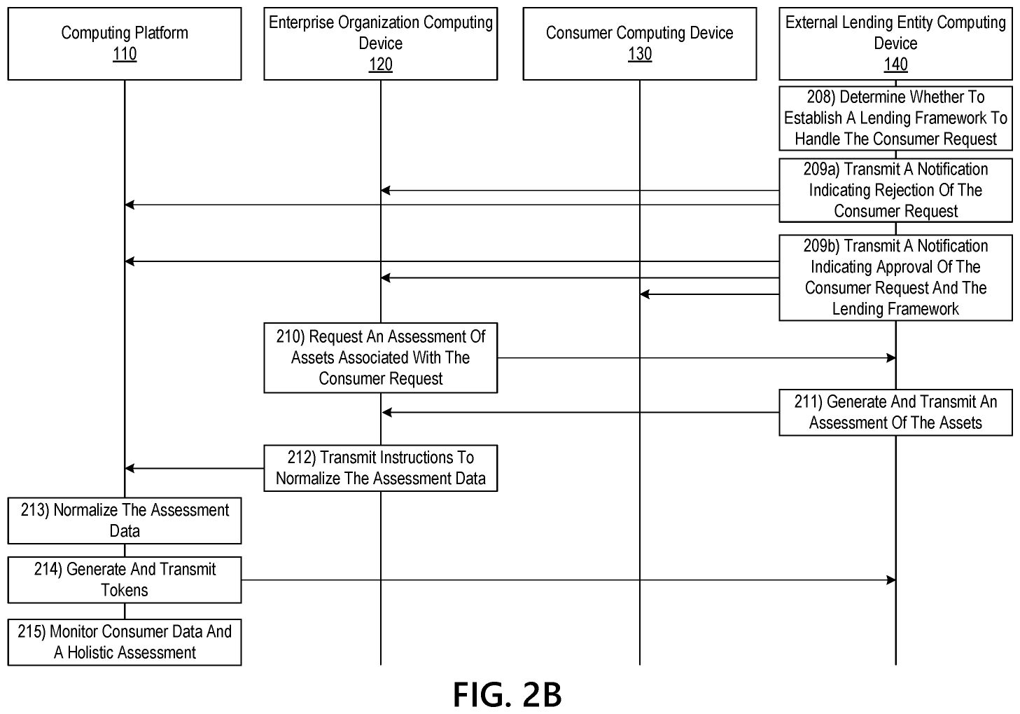

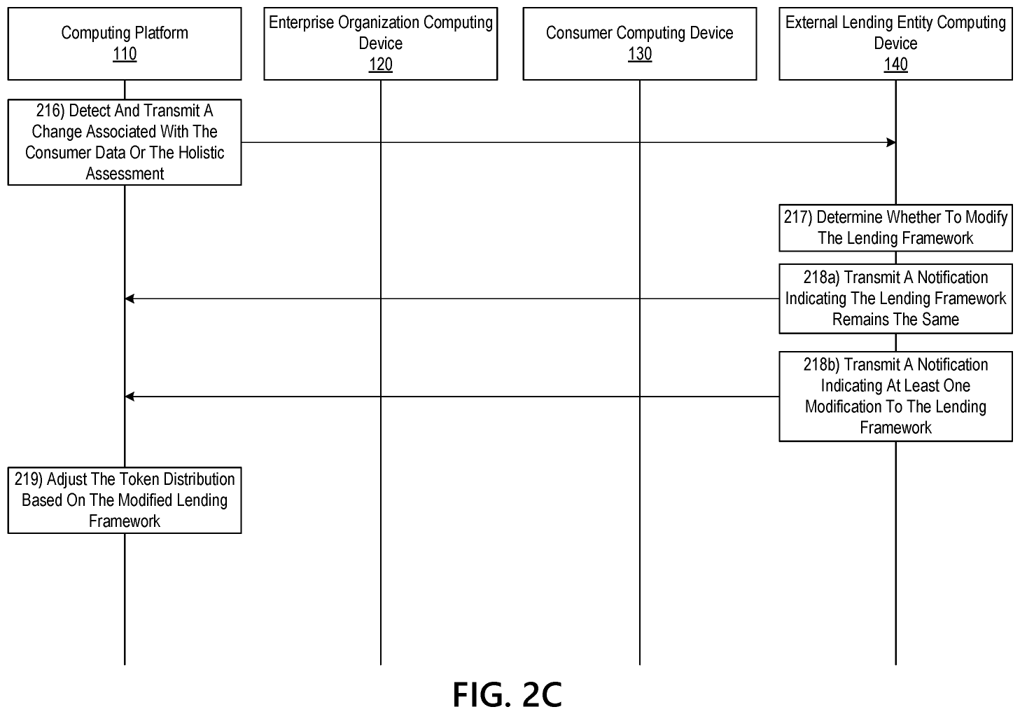

FIGS. 2A-2C depict an illustrative event sequence for establishing, in real-time or near real-time, a decentralized finance network, in accordance with one or more aspects described herein. While aspects described with respect to FIGS. 2A-2C include the evaluation of a single consumer request to initiate a transaction with the enterprise organization, a plurality of consumer requests may be received and evaluated (e.g., in parallel) without departing from the present disclosure. One or more processes performed in FIGS. 2A-2C may be performed in real-time or near real-time and one or more steps or processes may be added, omitted, or performed in a different order without departing from the present disclosure.

Referring to FIG. 2A, at step 201, consumer computing device 130 may generate a request to initiate a transaction with the enterprise organization (e.g., a request for a personal loan to purchase an automobile, a request for a commercial loan to purchase a commercial property, or the like). The consumer request may indicate at least one asset (e.g., the automobile, the commercial property, or the like). Consumer computing device 130 may transmit the consumer request to enterprise organization computing device 120 via network 150.

At step 202, enterprise organization computing device 120 may instruct computing platform 110 to analyze the consumer request.

At step 203, computing platform 110 may analyze the consumer request to determine a risk score associated with the consumer request. Computing platform 110 may parse the consumer request to extract data that may describe consumer computing device 130 (e.g., a credit score associated with consumer computing device 130, a credit history associated with consumer computing device 130, an account balance associated with consumer computing device 130, an employment history associated with consumer computing device 130, or the like). Computing platform 110 may store the extracted consumer data within consumer data database 111.

Computing platform 110 may determine weighted values associated with the extracted consumer data using consumer criteria that may be generated by the enterprise organization. The consumer criteria may indicate a weight that corresponds to each piece of consumer data that may be extracted from the consumer request. The consumer criteria may also comprise instructions for determining a risk score that corresponds to the consumer request and/or instructions for analyzing the risk score.

Computing platform 110 may use the weights indicated in the consumer criteria to determine a weighted value for each piece of extracted consumer data. Computing platform 110 may also use the instructions within the consumer criteria to combine the weighted values and generate the risk score. The risk score may indicate a likelihood of enterprise organization computing device 120 approving the consumer request. The risk score may correspond to a risk assessment threshold, generated by the enterprise organization, which may indicate a range of risk scores and/or corresponding likelihoods of approval. The risk assessment threshold may comprise a risk threshold value, which may correspond to the maximum risk score that may result in approval of the consumer request. Computing platform 110 may store the consumer request and the corresponding risk score within consumer request database 112.

At step 204, computing platform 110 may compare the risk score to the risk threshold value to determine whether enterprise organization computing device 120 should approve or reject the consumer request.

If, at step 204, computing platform 110 determines that the risk score is equal to or greater than the risk threshold value, then, at step 205a, computing platform 110 may recommend rejection of the consumer request. Computing platform 110 may transmit, to enterprise organization computing device 120, an analysis of the risk score and a recommendation indicating rejection of the consumer request.

Alternatively, if, at step 204, computing platform 110 determines that the risk score is less than the risk threshold value, then, at step 205b, computing platform 110 may recommend approval of the consumer request. Computing platform 110 may transmit, to enterprise organization computing device 120, the analysis of the risk score and a recommendation indicating approval of the consumer request.

At step 206, enterprise organization computing device 120 may parse the recommendations to determine whether to approve or reject the consumer request.

If, at step 206, enterprise organization computing device 120 determines, based on parsing the received analyses, that the risk score is less than the risk threshold value, then, at step 207a, enterprise organization computing device 120 may approve the consumer request. In some instances, approval of the consumer request may indicate that the enterprise organization may handle (e.g., provide financing for, or the like) the transaction indicated in the consumer request. Enterprise organization computing device 120 may transmit, to consumer computing device 130, a notification indicating approval of the consumer request.

However, if, at step 206, enterprise organization computing device 120 determines, based on parsing the received analyses, that the risk score is equal to or greater than the risk threshold value, then, at step 207b, enterprise organization computing device 120 may reject the consumer request and may identify at least one external lending entity that may be interested in supporting and/or handling (e.g., provide financing for, or the like) the transaction indicated in the consumer request. Based on determining external lending entity computing device 140a (referred to herein as external entity computing device 140) may be interested in supporting and/or handling the consumer request, enterprise organization computing device 120 may transmit, to external lending entity computing device 140, the consumer request, consumer data extracted from the consumer request, and/or a risk score that corresponds to the consumer request.

An external lending entity may correspond to an independent investor (e.g., an investor that might not be affiliated with the enterprise organization, or the like) that may be interested in supporting consumer requests associated with consumer computing devices that might not satisfy the consumer criteria. In some instances, the external lending entity may correspond to a single independent investor. Additionally or alternatively, the external lending entity may correspond to a plurality of independent investors that may identify as a single entity (e.g., a decentralized autonomous organization (DAO), or the like). In such instances, the DAO may determine whether to handle and/or support a consumer request based on a majority decision of independent investors within the DAO. If the majority of the DAO expresses an interest in handling and/or supporting the consumer request, then the majority of the DAO may be a first subset of independent investors (e.g., the independent investors that may provide a portion of or a total investment amount needed to handle and/or support the consumer request, or the like). The minority of the DAO may be a second subset of independent investors (e.g., the independent investors that might not be interested in providing a portion of or the total investment amount needed to handle and/or support the consumer request, or the like).

Referring to FIG. 2B and at step 208, external lending entity computing device 140 may receive, from enterprise organization computing device 120, the consumer request, extracted consumer data, and/or a corresponding risk score, and may use the received data to determine whether to support and/or handle the consumer request. In particular, external lending entity computing device 140 may determine whether to generate a lending framework indicating a total investment amount that external lending entity computing device 140 may provide to handle the consumer request. In instances where external lending entity computing device 140 may correspond to a DAO, the lending framework may identify the first subset of independent investors.

External lending entity computing device 140 may parse and analyze the received data. External lending entity computing device 140 may identify, based on the analysis, at least one factor that may impact the success of the transaction indicated in the consumer request (e.g., an account balance associated with consumer computing device 130 may suggest inability to successfully repay a personal loan, a credit history associated with consumer computing device 130 may indicate a history of defaulted loan payments, or the like). External lending entity computing device 140 may determine whether to approve or reject the consumer request based on the at least one identified factor.

If, at step 208, external lending entity computing device 140 determines that the at least one identified factor may hinder the success of the transaction, then, at step 209a, external lending entity computing device 140 may reject the consumer request. External lending entity computing device 140 may transmit, to computing platform 110 and enterprise organization computing device 120, a notification indicating rejection of the consumer request.

In some instances, based on receiving the notification indicating rejection of the consumer request, enterprise organization computing device 120 may query external lending entity computing device 140 to determine whether external lending entity computing device 140 may be interested in assessing the consumer request. Assessing the consumer request may consist of inspecting at least one asset indicated in the consumer request and identifying, based on the inspecting, a plurality of characteristics and/or features of the asset (e.g., a geographic location of a physical asset, a network location of a digital asset, a value of the asset, functionalities associated with the asset, damage that the asset sustained, or the like). The query may indicate that external lending entity computing device 140 may be able to generate interest (e.g., an ownership interest, a partial ownership interest, or the like) in the at least one asset indicated in the consumer request (e.g., without providing a portion of or the total investment amount needed for the consumer request, or the like). In some instances, external lending entity computing device 140 may transmit, to enterprise organization computing device 120, a notification indicating it is not interested in assessing the consumer request. Alternatively, external lending entity computing device 140 may transmit, to enterprise organization computing device 120, a notification indicating it is interested in assessing the consumer request. In such instances, enterprise organization computing device 120 may add external lending entity computing device 140 to a list of external lending entities interested in assessing consumer requests. In instances where external lending entity computing device 140 corresponds to a DAO, enterprise organization computing device 120 may add the second subset of independent investors to the list of external lending entities interested in assessing consumer requests (e.g., based on independent investors of the second subset indicating they are interested in assessing the consumer request but are not interested in handling the consumer request, or the like).

However, if, at step 208, external lending entity computing device 140 determines that the at least one factor might not hinder the success of the transaction, then, at step 209b, external lending entity computing device 140 may approve the consumer request and may generate the lending framework that corresponds to the consumer request. To do so, external lending entity computing device 140 may parse the consumer request to identify an investment amount and/or an investment range requested by consumer computing device 130. External lending entity computing device 140 may analyze the requested investment amount and/or investment range, and may indicate within the lending framework a total investment amount. In instances where external lending entity computing device 140 may correspond to a DAO, the lending framework may identify the first subset of independent investors and/or an investment amount that each independent investor of the first subset of independent investors may contribute to the total investment amount.

External lending entity computing device 140 may transmit a notification indicating approval of the consumer request and the lending framework to computing platform 110, enterprise organization computing device 120, and consumer computing device 130. Computing platform 110 may store, within consumer request database 112, an indication that the consumer request was approved by external lending entity computing device 140.

At step 210, enterprise organization computing device 120 may transmit, to a totality of external lending entity computing devices 140a-140c, a request to assess at least one asset indicated within the consumer request. In some instances, enterprise organization computing device 120 might not transmit the assessment request to the external lending entity handling the consumer request (e.g., external lending entity computing device 140a, or the like). In instances where external lending entity computing device 140 handling the consumer request may correspond to a DAO, enterprise organization computing device 120 transmit the assessment request to the second subset of independent investors. Additionally or alternatively, enterprise organization computing device 120 may transmit the assessment request to external lending entity computing devices 140a-140c based on a geographic location associated with external lending entity computing devices 140a-140c (e.g., based on determining external lending entity computing devices 140a-140c may be able to physically (as opposed to virtually) inspect the at least one asset, or the like).

The assessment request may indicate the at least one asset within the consumer request (e.g., the automobile for which consumer computing device 130 may request the personal loan, the commercial property for which consumer computing device 130 may request the commercial loan, or the like). The assessment request may further indicate a plurality of features associated with the at least one asset that external lending entity computing devices 140a-140c may identify and extract (e.g., a value of the asset, a geographic location of a physical asset, a network location of a digital asset, an indication of features associated with the asset, an indication of damage sustained by the asset, an indication of comparable assets and/or corresponding values, or the like).

At step 211, external lending entity computing devices 140a-140c may each generate an assessment of the at least one asset within the consumer request and may store the assessments within assessment data database 113. External lending entity computing devices 140a-140c may transmit the assessments to enterprise organization computing device 120.

At step 212, enterprise organization computing device 120 may receive assessments from at least one of external lending entity computing devices 140a-140c, and may transmit, to computing platform 110, instructions to normalize the data within the assessments.

At step 213, computing platform 110 may normalize the assessment data to generate a holistic assessment of the at least one asset. The holistic assessment of the at least one asset may be generated based on determining an accuracy of the received assessment data and/or based on removing assessment data that might not be consistent with at least one of current assessment data and/or previously received assessment data.

To generate the holistic assessment of the at least one asset, computing platform 110 may parse assessment data database 113 to identify at least one previously analyzed asset that may be similar to (e.g., the same as, within a pre-determined range of, or the like) the at least one asset indicated in the consumer request (e.g., previously analyzed assets of the same or similar type, previously analyzed assets with the same or similar features, previously analyzed assets that sustained the same or similar damage, or the like). Computing platform 110 may compare an assessment of the previously analyzed asset to the current assessment data to determine whether the current assessment data is consistent with (e.g., within a pre-determined range of, or the like) the assessments that correspond to the previously analyzed assets.

Based on determining the current assessment data is inconsistent with (e.g., not within the pre-determined range of, or the like) the assessments that correspond to the previously analyzed assets, computing platform 110 may remove the inconsistent assessment data from consideration. In particular, computing platform 110 may identify at least one component of the current assessment data (e.g., an assessment received from external lending entity computing device 140b, or the like) that may be inconsistent and may indicate, within assessment data database 113, that the at least one component of the current assessment data should not be used for generating the holistic assessment. In some instances, computing platform 110 may identify the external lending entity computing device that may have generated the inconsistent assessment data (e.g., external lending entity computing device 140b, or the like) and may monitor further assessment data received from the external lending entity computing device. Based on identifying a pattern of inconsistent assessment data from the external lending entity computing device, computing platform 110 may remove the external lending entity computing device from the list of external lending entity computing devices that may assess consumer requests.

However, based on determining the current assessment data is consistent with (e.g., within the pre-determined range of, or the like) the assessments that correspond to the previously analyzed assets, computing platform 110 may normalize the current assessment data. In instances where the assessment data that corresponds to a feature of the at least one asset may comprise numerical data, computing platform 110 may determine an average assessment value based on the assessment data. Additionally or alternatively, in instances where the assessment data that corresponds to a feature of the at least one asset might not comprise numerical data, computing platform 110 may compile all the assessment data associated with the feature (e.g., to generate a robust description of the feature, or the like). Computing platform 110 may use the average assessment values and/or the robust descriptions to generate the holistic assessment of the at least one asset.

At step 214, computing platform 110 may use the holistic assessment of the at least one asset to generate a token distribution framework. A token may represent a virtual indication of interest within and/or ownership of the at least one asset. The token distribution framework may identify external lending entity computing devices 140a-140c handling the consumer request that may receive a token for handling the consumer request (e.g., to indicate at least partial ownership of the at least one asset, or the like) and/or may identify external lending entity computing devices 140a-140c that may receive a token for assessing the consumer request (e.g., to indicate at least an interest within the at least one asset, or the like).

External lending entity computing devices 140a-140c may receive more than one token. To determine a number of tokens to be distributed to external lending entity computing devices 140a-140c, computing platform 110 may compare the value of the asset (e.g., extracted from the holistic assessment, or the like) to an investment amount and/or investment range associated with each of external lending entity computing devices 140a-140c. The distribution of tokens to external lending entity computing devices 140a-140c may be proportional to the investment amount and/or investment range associated with each of external lending entity computing devices 140a-140c.

In instances where at least one of external lending entity computing devices 140a-140c may correspond to a DAO, the distribution of tokens to each independent investor may be proportional to an investment amount that each independent investor may have contributed to the total investment amount indicated in the lending framework. However, in instances where at least one of external lending entity computing devices 140a-140c assessed the consumer request without contributing to the total investment amount indicated in the lending framework, the distribution of tokens may be based on a pre-determined distribution rate generated by the enterprise organization (e.g., more tokens may be distributed based on a demonstrated ability to generate consistent and/or accurate assessment data, fewer tokens may be distributed based on a demonstrated ability to generate inconsistent and/or inaccurate assessment data, or the like). Computing platform 110 may distribute the tokens based on the token distribution framework.

At step 215, computing platform 110 may continuously monitor consumer computing device 130 to identify changes to the previously identified consumer data (e.g., an updated credit score associated with consumer computing device 130, an updated credit history associated with consumer computing device 130, an updated account balance associated with consumer computing device 130, an updated employment history associated with consumer computing device 130, updated outstanding loan repayment balances associated with consumer computing device 130, or the like).

In some instances, computing platform 110 may continuously receive assessment data from enterprise organization computing device 120 and may continuously normalize the assessment data, in accordance with the methods described above. Computing platform 110 may continuously compare the holistic assessment to an updated holistic assessment to identify at least one change in at least one feature associated with the at least one asset (e.g., an updated asset value, an updated indication of features associated with the asset, an updated indication of damage sustained by the asset, or the like).

Referring to FIG. 2C, and at step 216, computing platform 110 may detect at least one change within the consumer data and/or at least one change within the holistic assessment (e.g., based on continuously monitoring the consumer data, based on continuously monitoring the holistic assessment, or the like). Computing platform 110 may transmit the at least one change to external lending entity computing device 140 that may handle and/or support the consumer request.

At step 217, external lending entity computing device 140 that may handle and/or support the consumer request may receive the at least one change and may determine whether to modify the lending framework based on the at least one change (e.g., based on a decrease in the account balance associated with consumer computing device 130, based on an increased credit score associated with the consumer computing device 130, based on a decreased asset value, or the like). In instances where external lending entity computing device 140 may correspond to a DAO, the first subset of independent investors may communicate (e.g., via network 150) to determine whether to modify the lending framework. Additionally or alternatively, in instances where more than one external lending entity computing device may handle and/or support the consumer request, the external lending entity computing devices handling and/or supporting the consumer request may communicate (e.g., via network 150) to determine whether to modify the lending framework generated by each external lending entity computing device.

If, at step 217, external lending entity computing device 140 determines that the at least one change might not affect the lending framework, then, at step 218a, external lending entity computing device 140 may transmit, to computing platform 110, a notification indicating the lending framework may remain the same.

Alternatively, if, at step 217, external lending entity computing device 140 determines that the at least one change may affect the lending framework, then, at step 218b, external lending entity computing device 140 may modify the lending framework and may transmit, to computing platform 110, a notification indicating at least one modification to the lending framework (e.g., an updated first subset of independent investors based on at least one independent investor backing out of the total investment amount based on a change in the consumer data, or the like).

At step 219, computing platform 110 may receive the modified lending framework and may update the token distribution framework accordingly. In some instances, computing platform 110 may transmit, to consumer computing device 130, a notification indicating at least one change to the total investment amount indicated in the lending framework.

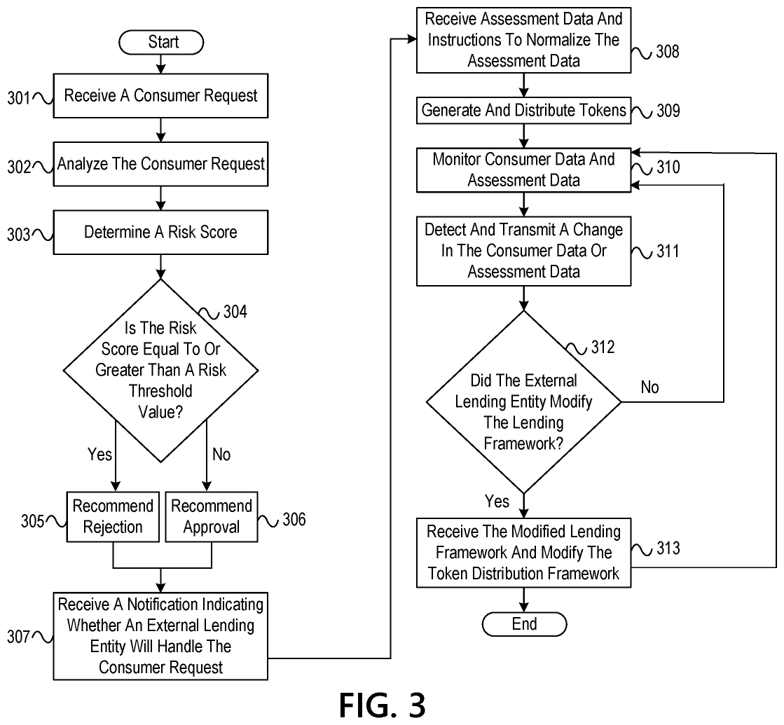

FIG. 3 depicts an illustrative event sequence for establishing, in real-time or near real-time, a decentralized finance network, in accordance with one or more aspects described herein. While aspects described with respect to FIG. 3 include the evaluation of a single consumer request, a plurality of consumer requests may be evaluated (e.g., in parallel) without departing from the present disclosure. One or more processes performed in FIG. 3 may be performed in real-time or near real-time and one or more steps or processes may be added, omitted, or performed in a different order without departing from the present disclosure.

At step 301, computing platform 110 may receive, from enterprise organization computing device 120, the consumer request (e.g., a request for a personal loan to purchase an automobile, a request for a commercial loan to purchase a commercial property, or the like) and instructions to analyze the consumer request.

At step 302, computing platform 110 may analyze the consumer request. In particular, computing platform 110 may parse the consumer request to extract data that may describe consumer computing device 130.

At step 303, computing platform 110 may determine weighted values associated with the extracted consumer data using consumer criteria that may be generated by the enterprise organization. The consumer criteria may indicate a weight that corresponds to each piece of consumer data that may be extracted from the consumer request. The consumer criteria may also comprise instructions for determining a risk score that corresponds to the consumer request and/or instructions for analyzing the risk score. Computing platform 110 may use the weights indicated in the consumer criteria to determine a weighted value for each piece of extracted consumer data. Computing platform 110 may also use the instructions within the consumer criteria to combine the weighted values and generate the risk score.

At step 304, computing platform 110 may compare the risk score to a risk threshold value, which may correspond to the maximum risk score that may result in approval of the consumer request. In particular, computing platform 110 may determine whether the risk score is equal to or greater than the risk threshold value.

If, at step 304, computing platform 110 determines that the risk score is equal to or greater than the risk threshold value, then, at step 305, computing platform 110 may recommend rejection of the consumer request. Computing platform 110 may transmit, to enterprise organization computing device 120, an analysis of the risk score and a recommendation indicating rejection of the consumer request.

Alternatively, if, at step 304, computing platform 110 determines that the risk score is less than the risk threshold value, then, at step 306, computing platform 110 may recommend approval of the consumer request. Computing platform 110 may transmit, to enterprise organization computing device 120, the analysis of the risk score and a recommendation indicating approval of the consumer request.

At step 307, computing platform 110 may receive a notification from external lending entity computing device 140. In some instances, the notification may indicate rejection of the consumer request. However, in some instances, the notification may indicate approval of the consumer request. The notification indicating approval of the consumer request may also comprise a lending framework that corresponds to the consumer request, which may identify a total investment amount from external lending entity computing device 140.

At step 308, computing platform 110 may receive, from enterprise organization computing device 120, assessment data generated by at least one of external lending entity computing devices 140a-140c (e.g., that corresponds to the at least one asset indicated in the consumer request, or the like) and instructions to normalize the assessment data. Computing platform 110 may normalize the assessment data to generate a holistic assessment of the at least one asset indicated in the consumer request.

To generate the holistic assessment of the at least one asset, computing platform 110 may parse assessment data database 113 to identify at least one previously analyzed asset that may be similar to (e.g., the same as, within a pre-determined range of, or the like) the at least one asset indicated in the consumer request. Computing platform 110 may compare an assessment of the previously analyzed asset to the current assessment data to determine whether the current assessment data is consistent with (e.g., within a pre-determined range of, or the like) the assessments that correspond to the previously analyzed assets.

Based on determining the current assessment data is inconsistent with (e.g., not within the pre-determined range of, or the like) the assessments that correspond to the previously analyzed assets, computing platform 110 may remove the inconsistent assessment data from consideration. However, based on determining the current assessment data is consistent with (e.g., within the pre-determined range of, or the like) the assessments that correspond to the previously analyzed assets, computing platform 110 may normalize the current assessment data.

In instances where the assessment data that corresponds to a feature of the at least one asset may comprise numerical data, computing platform 110 may determine an average assessment value based on the assessment data. Additionally or alternatively, in instances where the assessment data that corresponds to a feature of the at least one asset might not comprise numerical data, computing platform 110 may compile all the assessment data associated with the feature (e.g., to generate a robust description of the feature, or the like). Computing platform 110 may use the average assessment values and/or the robust descriptions to generate the holistic assessment of the at least one asset.

At step 309, computing platform 110 may use the holistic assessment of the at least one asset to generate a token distribution framework, which may identify external lending entity computing devices 140a-140c handling the consumer request that may receive a token for handling the consumer request and/or may identify external lending entity computing devices 140a-140c that may receive a token for assessing the consumer request. 140c. The distribution of tokens to external lending entity computing devices 140a-140c may be proportional to the investment amount and/or investment range associated with each of external lending entity computing devices 140a-140c. However, in instances where at least one of external lending entity computing devices 140a-140c assessed the consumer request without contributing to the total investment amount indicated in the lending framework, the distribution of tokens may be based on a pre-determined distribution rate generated by the enterprise organization. Computing platform 110 may distribute the tokens based on the token distribution framework.

At step 310, computing platform 110 may continuously monitor consumer computing device 130 to identify changes to the previously identified consumer data. In some instances, computing platform 110 may continuously receive assessment data from enterprise organization computing device 120 and may continuously normalize the assessment data, in accordance with the methods described above. Additionally or alternatively, computing platform 110 may monitor consumer computing device 130 for a pre-determined amount of time (e.g., until the consumer request is satisfied, until a loan requested in the consumer request is satisfied, for a duration of the loan requested in the consumer request, or the like).

At step 311, computing platform 110 may detect at least one change within the consumer data and/or at least one change within the holistic assessment, and may transmit the at least one change to external lending entity computing device 140 that may handle and/or support the consumer request.

At step 312, computing platform 110 may determine whether external lending entity computing device 140 modified the lending framework that corresponds to the consumer request.

If, at step 312, computing platform 110 determines that external lending entity computing device 140 might not have modified the lending framework, the process described herein may return to step 310 in that computing platform 110 may continuously monitor the consumer data and assessment data to determine whether at least one of the consumer data and/or the assessment data (e.g., the holistic assessment, or the like) may have changed.

However, if, at step 312, computing platform 110 determines that external lending entity computing device 140 may have modified the lending framework, then, at step 313, computing platform 110 may receive the modified lending framework, and may update the token distribution framework and the token distribution accordingly. Furthermore, the process described herein may return to step 310 in that computing platform 110 may continuously monitor the consumer data and assessment data (e.g., until the consumer request is satisfied, until a loan requested in the consumer request is satisfied, for a duration of the loan requested in the consumer request, or the like).

As a result, the proposed solution may provide the following benefits: 1) real-time, or near real-time, generation of a P2P lending network comprising the plurality of external lending entity computing devices; 2) real-time, or near real-time, consumer computing device identification and risk assessment to determine whether to approve or reject a consumer request; 3) real-time, or near real-time, transmission of a rejected consumer request to a plurality of external lending entity computing devices; 4) real-time, or near real-time, assessment of assets associated with the consumer request; and 5) real-time, or near real-time, distribution of tokens to external lending entity computing devices handling the consumer request.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an enterprise computing platform, or as one or more non-transitory computer-readable media storing instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space).

As described herein, the various methods and acts may be operative across one or more computing servers and one or more networks. The functionality may be distributed in any manner, or may be located in a single computing device (e.g., a server, a user computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method comprising:
at a computing device, within a peer-to-peer (P2P) lending network, including one or more processors and memory:
receiving, from an enterprise organization computing device, a consumer request to initiate a transaction with an enterprise organization;
determining, based on analyzing the consumer request, a risk score that corresponds to the consumer request;
determining, based on the risk score, whether to approve the consumer request;
receiving, from an external lending entity, a notification indicating approval of the consumer request, wherein the notification identifies a total investment amount;
receiving, from the enterprise organization computing device, an assessment of an asset, generated by at least one other external lending entity, associated with the consumer request;
generating, based on the assessments, a plurality of tokens;
distributing tokens, of the plurality of tokens, to the external lending entity and the at least one other external lending entity;
receiving, from the enterprise organization computing device, an indication of at least one change to the assessment, wherein the indication is generated by the at least one other external lending entity;
transmitting the at least one change to the external lending entity; and
receiving, from the external lending entity, a notification indicating at least one of:
no modification to the total investment amount, or
at least one modification to the total investment amount.

2. The method of claim 1, wherein the determining the risk score further comprises:
analyzing at least one of:
a credit score associated with the consumer computing device,
a credit history associated with the consumer computing device,
an account balance associated with the consumer computing device, or
an employment history associated with the consumer computing device; and
assigning a weight to at least one of:
the credit score,
the credit history,
the account balance, or
the employment history.

3. The method of claim 1, wherein the determining whether to approve the consumer request further comprises comparing the risk score to a risk assessment threshold,
wherein the risk assessment threshold comprises a risk threshold value, and
wherein the risk threshold value indicates a maximum risk score corresponding to approval of the consumer request.

4. The method of claim 3, further comprising rejecting the consumer request based on determining the risk score is equal to or greater than the risk threshold value.

5. The method of claim 3, further comprising approving the consumer request based on determining the risk score is less than the risk threshold value.

6. The method of claim 1, wherein the assessment of the asset comprises at least one of:
a value of the asset;
a location of the asset, wherein the location corresponds to at least one of:
a geographic location of a physical asset, or
a network location of a digital asset;
an indication of features associated with the asset, wherein the indication of features may identify damage to the asset; or
an indication of comparable assets and corresponding values.

7. The method of claim 1, wherein the receiving the assessment further comprises:
normalizing the assessments generated by the at least one other external lending entity; and
generating, based on the normalizing, a holistic assessment of the asset.

8. The method of claim 7, wherein the normalizing the assessments further comprises:
identifying, based on parsing an assessment history, similar previously analyzed assets;
comparing, for each assessment from each external assessment entity, an assessment of the asset to assessments of the similar previously analyzed assets;
determining, based on the comparing, an accuracy of the assessment of the asset; and
based on determining the assessment of the asset is accurate, generating the holistic assessment of the asset.

9. The method of claim 8, further comprising, based on determining the assessment of the asset is inaccurate, removing the assessment of the asset from consideration.

10. The method of claim 1, wherein the external lending entity corresponds to a decentralized autonomous organization (DAO) comprising a plurality of independent investors, wherein the plurality of independent investors comprises at least one of:
a first subset of independent investors providing a portion of the total investment amount, or
a second subset of independent investors not interested in the consumer request.

11. The method of claim 10, wherein the notification indicating approval of the consumer request further comprises at least one of the first subset of independent investors or the second subset of independent investors.

12. The method of claim 10, wherein the distributing the tokens to the external lending entity further comprises:
identifying a proportion of the total investment amount that corresponds to each independent investor of the first subset of independent investors; and
distributing, to each independent inventor of the first subset, a quantity of tokens proportional to the proportion of the total investment amount that corresponds to the independent investor.

13. The method of claim 1, further comprising, receiving, from the external lending entity, a notification indicating denial of the consumer request.

14. The method of claim 1, further comprising, transmitting, to the consumer computing device, the notification indicating the at least one modification to the total investment amount.

15. A computing platform, within a peer-to-peer (P2P) lending network, comprising:
at least one processor;
a communication interface communicatively coupled to the at least one processor; and
memory storing computer-readable instructions that, when executed by the at least one processor, cause the computing platform to:
receive, from an enterprise organization computing device, a consumer request to initiate a transaction with an enterprise organization;
determine, based on analyzing the consumer request, a risk score that corresponds to the consumer request;
determine, based on the risk score, whether to approve the consumer request;
receive, from an external lending entity, a notification indicating approval of the consumer request, wherein the notification identifies a total investment amount;
receive, from the enterprise organization computing device, an assessment of an asset, generated by at least one other external lending entity, associated with the consumer request;
generate, based on the assessments, a plurality of tokens;
distribute tokens, of the plurality of tokens, to the external lending entity and the at least one other external lending entity;
receive, from the enterprise organization computing device, an indication of at least one change to the assessment, wherein the indication is generated by the at least one other external lending entity;
transmit the at least one change to the external lending entity; and
receive, from the external lending entity, a notification indicating at least one of:
no modification to the total investment amount, or
at least one modification to the total investment amount.

16. The computing platform of claim 15, wherein the determining whether to approve the consumer request further comprises comparing the risk score to a risk assessment threshold,
wherein the risk assessment threshold comprises a risk threshold value, and
wherein the risk threshold value indicates a maximum risk score corresponding to approval of the consumer request.

17. The computing platform of claim 15, wherein the assessment of the asset comprises at least one of:
a value of the asset;
a location of the asset, wherein the location corresponds to at least one of:
a geographic location of a physical asset, or
a network location of a digital asset;
an indication of features associated with the asset, wherein the indication of features may identify damage to the asset; or
an indication of comparable assets and corresponding values.

18. The computing platform of claim 15, wherein the receiving the assessment further causes the computing platform to:
normalize the assessments generated by the at least one other external lending entity; and
generate, based on the normalizing, a holistic assessment of the asset.

19. One or more non-transitory computer-readable media storing instructions that, when executed by a computing platform, within a peer-to-peer (P2P) lending network, comprising at least one processor, memory, and a communication interface, cause the computing platform to:
receive, from an enterprise organization computing device, a consumer request to initiate a transaction with an enterprise organization;
determine, based on analyzing the consumer request, a risk score that corresponds to the consumer request;
determine, based on the risk score, whether to approve the consumer request;
receive, from an external lending entity, a notification indicating approval of the consumer request, wherein the notification identifies a total investment amount;
receive, from the enterprise organization computing device, an assessment of an asset, generated by at least one other external lending entity, associated with the consumer request;
generate, based on the assessments, a plurality of tokens;
distribute tokens, of the plurality of tokens, to the external lending entity and the at least one other external lending entity;
receive, from the enterprise organization computing device, an indication of at least one change to the assessment, wherein the indication is generated by the at least one other external lending entity;
transmit the at least one change to the external lending entity; and
receive, from the external lending entity, a notification indicating at least one of:
no modification to the total investment amount, or
at least one modification to the total investment amount.

20. The non-transitory computer-readable media of claim 19, wherein the assessment of the asset comprises at least one of:
a value of the asset;
a location of the asset, wherein the location corresponds to at least one of:
a geographic location for a physical asset, or
a network location for a digital asset;
an indication of features associated with the asset, wherein the indication of features may identify damage to the asset; or
an indication of comparable assets and corresponding values.
